(19) United States
(12) Patent Application Publication
(10) Pub. No.: US 2015/0221487 A9
(43) Pub. Date: Aug. 6, 2015

(54) SURFACE ADSORPTION VACUUM PUMPS AND METHODS FOR PRODUCING ADSORBATE-FREE SURFACES

(71) Applicants: ARASH AKHAVAN FOMANI, MELROSE, MA (US); AKINTUNDE IBITAYO AKINWANDE, NEWTON, MA (US); LUIS FERNANDO VELASQUEZ-GARCIA, NEWTON, MA (US)

(72) Inventors: ARASH AKHAVAN FOMANI, MELROSE, MA (US); AKINTUNDE IBITAYO AKINWANDE, NEWTON, MA (US); LUIS FERNANDO VELASQUEZ-GARCIA, NEWTON, MA (US)

(21) Appl. No.: 14/067,695

(22) Filed: Oct. 30, 2013

Related U.S. Application Data
(60) Provisional application No. 61/845,553, filed on Jul. 12, 2013.
(60) Provisional application No. 61/821,452, filed on May 9, 2013.

(51) Int. Cl. H01J 41/12

(52) U.S. Cl. CPC H01J 41/12

(57) ABSTRACT

Methods for pumping a chamber to generate substantially adsorbate-free surfaces are described. Pumping systems for achieving a vacuum based on surface adsorption are also described.

### CROSS-REFERENCE TO RELATED APPLICATION

The present application claims a priority benefit to U.S. provisional application Ser. No. 61/845,553, filed Jul. 12, 2013, entitled “SURFACE ADSORPTION VACUUM PUMPS AND METHODS FOR PRODUCING ADSORBATE-FREE SURFACES,” which is hereby incorporated by reference in its entirety, including drawings.

### GOVERNMENT SUPPORT

This invention was made with government support under Grant No. W31P4Q-10-1-0005 awarded by the Defense Advanced Research Projects Agency. The government has certain rights in the invention.

### BACKGROUND

Miniaturized low-power pumps are needed for the development of a broad range of portable/distributed high-performance sensors and analytical instruments. Currently, the size and power consumption of vacuum pumps, including ultra-high vacuum (UHV) pumps, are significantly larger than that of other components in these systems. Furthermore, many of these sensors and analytical instruments need to be operated under vacuum conditions for optimal performance. Although the devices are packaged in hermetically-sealed packaging under a vacuum, the vacuum degrades over time, which can compromise device performance.

### SUMMARY

The Inventors have recognized and appreciated that a method of producing adsorbate-free surfaces would be beneficial. The Inventors have also recognized that such a method can be implemented to provide a surface adsorption pump. In view of the foregoing, various embodiments are directed generally to methods for generating a vacuum in a chamber, and apparatus and systems that are configured to generate a vacuum in a chamber based on the methods.

In a first aspect, an example method is provided for generating a vacuum in a chamber. The example method includes operating a pump in communication with a chamber to reduce a pressure in the chamber to a first value of medium vacuum pressure, supplying to a portion of the chamber an amount of energy that exceeds a heat of adsorption of adsorbate molecules on a surface of the chamber, where the amount of energy is supplied by ion bombardment, electron bombardment, or heating, maintaining the chamber in communication with the pump, and isolating the chamber from the pump while the pressure in the chamber is at a second value of medium vacuum pressure. The pressure in the chamber decreases from the second value of medium vacuum pressure to a lower value of pressure in the absence of additional evacuation of the chamber.

In an example, the first value of medium vacuum pressure and/or the second value of medium vacuum pressure can have a value within a range from about 1×10⁻¹ Torr to about 1×10⁻⁹ Torr. For example, the first value of medium vacuum pressure and/or the second value of medium vacuum pressure can be about 1×10⁻³ Torr. In an example, the lower value of pressure has a value within a range from about 1×10⁻⁵ Torr to about 1×10⁻¹⁰ Torr. For example, the lower value of pressure can be about 1×10⁻⁹ Torr.

In an example, the amount of energy can be about 0.05 eV, about 0.1 eV, about 0.5 eV, about 1 eV, about 5 eV, about 7.5 eV, about 10 eV, or about 12 eV.

In an example, the example method can further include supplying the amount of energy by ion bombardment or electron bombardment. The ion bombardment can be supplied using at least one field emitter, at least one field ionizer, or at least one thermionic source, where the at least one field emitter, at least one field ionizer, or at least one thermionic source is disposed in or coupled to a portion of the chamber. The electron bombardment can be supplied using at least one of a gas discharge, a direct-current plasma, a radio-frequency plasma, electron impact ionization, and field ionization, disposed in or coupled to a portion of the chamber.

In an example, the example method can further include supplying the amount of energy by heating, wherein said heating is supplied using at least one radiative heater or at least one resistive heater disposed in or coupled to a portion of the chamber. The example method may further include discontinuing the supplying of the amount of energy to the portion of the chamber prior to isolating the chamber from the pump.

In an example, the pump can be a mechanical pump, a turbo-pump, a positive displacement pump, a diffusion pump, a turbomolecular pump, a Knudsen pump, a cryo-pump or an ion pump. The positive displacement pump is a rotary pump, a scroll pump, a screw pump, and a diaphragm pump.

In an example, the example method can further include maintaining the chamber in communication with the pump until an equilibrium pressure is reached at a base pressure of the pump.

In an example, the example method further includes discontinuing the supplying the amount of energy after isolating the chamber from the pump.

In a second aspect, an example method is provided for packaging at least one device under a vacuum. The example method includes disposing the at least one device in a housing, operating a pump in communication with the housing to reduce a pressure in the housing to a first value of medium vacuum pressure, supplying to the housing an amount of energy that exceeds a heat of adsorption of adsorbate molecules in the housing, while maintaining the housing in communication with the pump, where the amount of energy is supplied by ion bombardment, electron bombardment, or heating, and isolating the housing from the pump when the pressure in the housing is at a second value of medium vacuum pressure. The pressure in the housing decreases from the second value of medium vacuum pressure to a lower value of pressure in the absence of additional evacuation of the housing.

In an example, the example method can further include supplying the amount of energy by ion bombardment, where the ion bombardment is supplied using at least one field emitter, at least one field ionizer, or at least one thermionic source. For example, the example method further includes supplying the amount of energy by electron bombardment, where the electron bombardment is supplied using at least one of a gas discharge, a direct-current plasma, a radio-frequency plasma, electron impact ionization, and field ionization.

In an example, the at least one device can be a micro-electromechanical system (MEMS) device, a sensor, a mass spectrometer, a gas chromatography system, or a tandem system.

In an example, the at least one device can be a magnetometer, an atomic clock, a gyroscope, an interferometer, an accelerometer, a gravimeter, an electric field sensor, a magnetic sensor, a pressure sensor, a gravity gradiometer, a power amplifier, a terahertz generator.

In an example, the first value of medium vacuum pressure and/or the second value of medium vacuum pressure has a value within a range from about 1×10⁻¹ Torr to about 1×10⁻⁹ Torr.

In an example, the lower value of pressure can have a value within a range from about 1×10⁻⁵ Torr to about 1×10⁻¹⁰ Torr. For example, the lower value of pressure can be about 1×10⁻⁹ Torr.

In an example, the amount of energy can be about 0.05 eV, about 0.1 eV, about 0.5 eV, about 1 eV, about 5 eV, about 7.5 eV, about 10 eV, or about 12 eV.

In a third aspect, an example surface adsorption pump is provided. The example surface adsorption pump includes a first chamber includes a first port and a second port, wherein the first port couples to a vacuum pump, at least one source for ion bombardment or electron bombardment disposed in or coupled to a portion of the first chamber, and a second chamber in gaseous communication with the first chamber via the second port.

In an example, the at least one source for electron bombardment is at least one field emitter, at least one field ionizer, or at least one thermionic source. For example, the at least one source for ion bombardment can be at least one at least one of gas discharge, direct-current plasma, radio-frequency plasma, electron impact ionization, or field ionization source.

In an example, the example surface adsorption pump further includes a valve disposed in the first port and/or the second port, where closing the valve in the first port and/or the second port substantially eliminates gaseous exchange through the respective first port and/or respective second port.

In a fourth aspect, an example method id provided for generating a vacuum using a surface adsorption pump. The method includes providing a surface adsorption pump according to any of the principles described herein, using a vacuum pump coupled to the first port to evacuate both the first chamber and the second chamber to a first value of medium vacuum pressure, while the first chamber is in gaseous communication with both the second chamber and the vacuum pump, activating the at least one source for ion bombardment or electron bombardment to supply to the first chamber an amount of energy that exceeds a heat of adsorption of adsorbate molecules in the first chamber, while the first chamber is in gaseous communication with the vacuum pump and isolated from the second chamber, until the first chamber is at a second value of medium vacuum pressure, and establishing gaseous communication between the first chamber and the second chamber, while the first chamber is isolated from the vacuum pump. The pressure in both the first chamber and the second chamber decrease from the second value of medium vacuum pressure to lower values of pressure in the absence of additional evacuation of the first chamber or the second chamber.

In an example, the example method further includes maintaining the first chamber in communication with the vacuum pump until an equilibrium pressure is reached at a base pressure of the vacuum pump.

In an example, the example method includes discontinuing the supply to the first chamber of the amount of energy after isolating the first chamber from the vacuum pump.

In a fifth aspect, an example surface adsorption pump is provided that includes a first chamber. The first chamber including a first port that couples to a vacuum pump, a second port, at least one adsorption plate disposed in the first chamber, and at least one source for ion bombardment or electron bombardment disposed in or coupled to a portion of the first chamber.

In an example, the example surface adsorption pump can further include a second chamber in gaseous communication with the first chamber via the second port.

In an example, the at least one source for electron bombardment can be at least one field emitter, at least one field ionizer, or at least one thermionic source. For example, the at least one source for ion bombardment can be at least one at least one of gas discharge, direct-current plasma, radio-frequency plasma, electron impact ionization, or field ionization source.

In an example, the example surface adsorption pump can further include a valve disposed in the first port and/or the second port, where closing the valve in the first port and/or the second port substantially eliminates gaseous exchange through the respective first port and/or respective second port.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates molecule adsorbed on a surface, according to principles of the present disclosure.

FIG. 1B illustrates an example of desorption of a molecule from a surface using energetic electron or ion bombardment, according to principles of the present disclosure.

FIG. 2 shows a flow-chart of an example method for generating a vacuum in a chamber, according to principles of the present disclosure.

FIGS. 3A-3D show an example pumping, according to principles of the present disclosure.

FIG. 4 shows a flowchart of an example method for packaging a device under a vacuum, according to principles of the present disclosure.

FIG. 5 shows a schematic of an example system where an energy source is disposed in the chamber, according to principles of the present disclosure.

FIGS. 6A-6D show example two-stage surface adsorption pump systems that can be operated as high vacuum pumps, according to principles of the present disclosure.

FIG. 7 shows a flow-chart of an example method for generating a vacuum using an example two-stage surface adsorption pump system, according to principles of the present disclosure.

FIGS. 8A-8D show an example operation sequence of an example two-stage surface adsorption pump system, according to principles of the present disclosure.

### DETAILED DESCRIPTION

Following below are more detailed descriptions of various concepts related to, and embodiments of, inventive methods, apparatus, and systems including surface adsorption pumps and methods for producing adsorbate-free surfaces. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

With respect to substrates or other surfaces described herein in connection with various examples of the principles herein, any references to “top” surface and “bottom” surface are used primarily to indicate relative position, alignment and/or orientation of various elements/components with respect to the substrate and each other, and these terms do not necessarily indicate any particular frame of reference (e.g., a gravitational frame of reference). Thus, reference to a “bottom” of a substrate or a layer does not necessarily require that the indicated surface or layer be facing a ground surface. Similarly, terms such as “over,” “under,” “above,” “beneath” and the like do not necessarily indicate any particular frame of reference, such as a gravitational frame of reference, but rather are used primarily to indicate relative position, alignment and/or orientation of various elements/components with respect to the substrate (or other surface) and each other. The terms “disposed on” and “disposed over” encompass the meaning of “embedded in,” including “partially embedded in.” In addition, reference to feature A being “disposed on,” “disposed between,” or “disposed over” feature B encompasses examples where feature A is in contact with feature B, as well as examples where other layers and/or other components are positioned between feature A and feature B.

Various micro-electromechanical system (MEMS) and nano-electro-mechanical system (NEMS) devices, such as but not limited to physical and inertial sensors based on atomic spectroscopy, e.g., clocks, magnetometers, gyroscopes, interferometer accelerometers, gravimeters, electric field sensors, and gravity gradiometers, can require very high vacuums to operate. For example, these devices can be initially packaged at pressures of about 10⁻⁵ Torr. However, the pressure inside the cavity can rise gradually over time, mainly due to leakage through the encapsulation of the device package. Eventually, the pressure inside the cavity can rise to such an extent that the device can be damages or proper operation or the device is diminished or prevented. Moreover, the device performance in terms of sensitivity, dynamic range, or stability is affected by the cavity pressure in which the device is encapsulated. The capability to create and maintain pressures of about 10⁻⁵ Torr or less, even as low as about 10⁻⁹ Torr, inside the encapsulation cavity can significantly advance the state-of-the-art in many compact and portable sensors and instruments by preserving device lifetime and performance quality.

Systems, apparatus and methods described herein can be used to provide low power pumping devices that can be used to create and maintain pressures of about 10⁻⁵ Torr or less, even as low as about 10⁻⁹ Torr. In an example, the systems, apparatus and methods described herein can be used to provide low power pumping devices that can be miniature. For example, the pumping devices can be miniaturized to be the size of an encapsulation cavity of a MEMS device or NEMS device. In an example, the pumping devices can be used as the packaging for the MEMS device or NEMS device.

Systems, apparatus and methods described herein can be used to provide a pumping device for UHV pumping that can be miniaturized for on-chip applications. An example pumping device according to the systems, apparatus and methods described herein can be used to maintain a closed system, such as but not limited to an isolated chamber, at low pressures for a longer period of time than existing pumps.

Systems, apparatus and methods described herein also can be used as a second stage of a compound pump for UHV pumping of open systems with low mass flow rate exchange with the exterior. This example mode of operation exemplifies the application of the pumping device for analytical instruments such as portable/field-deployable/distributed autonomous mass spectrometry systems.

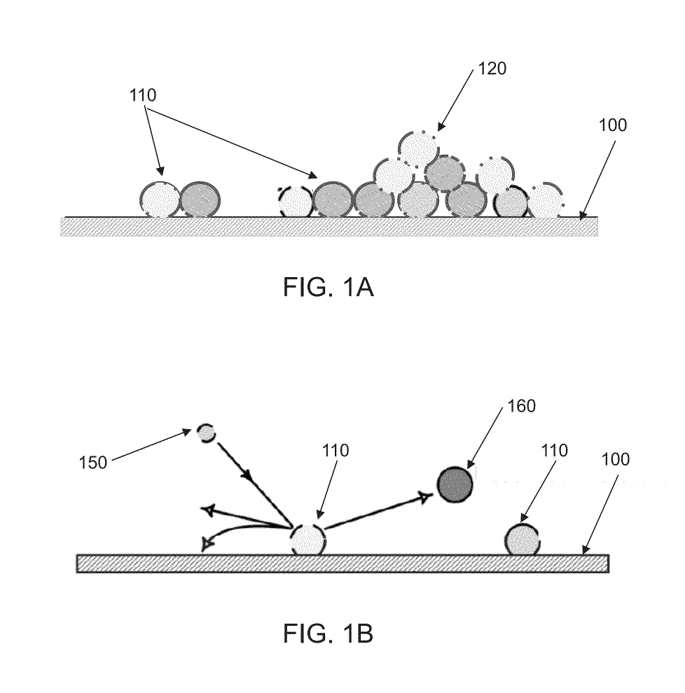

FIG. 1A shows an example surface 100 that includes adsorbed molecules 110, 120. Example surface 100 can be a portion of a chamber, such as but not limited to a portion of a getter in the chamber. The surfaces of solids tend to adsorb and tightly hold at least one monolayer of molecules adsorbed at the surface with heats of adsorption as high as about 5 eV to about 10 eV. Molecules 120 are adsorbed at higher levels of the adsorbed multilayer, and can be adsorbed with lower heats of adsorption. Therefore, the molecules 110 adsorbed at the surface 100 do not have sufficient energy to leave the surface 100. According to an example method, the molecules 110 adsorbed at the surface 100 can be excited to the gas phase by supplying energy to the chamber. The energy should be an amount that is sufficient to cause desorption of at least a portion of the adsorbed molecules 110 of the monolayer. In an example, the energy can be supplied by heating a portion of the chamber, such as but not limited to the getter. In an example, the energy can be supplied by charged particles, such as energetic electrons or ions, that are accelerated at a portion of the surface 100. For example, the charged particles can be accelerated towards a portion of the surface of a getter. A collision of the accelerated charged particle and a molecule adsorbed at the surface can be used to impart sufficient energy to the adsorbed molecule for it to be desorbed from the surface. A substantially adsorbate-free surface can be produced based on the use of the heating or charged particle, according to the principles described herein.

A getter can be disposed as a coating on any portion of the surface of the chamber as a layer of reactive material. The reactive material can be configured for generating and maintaining a vacuum in the chamber. For example, the reactive material can be configured such that gas molecules adsorb to the surface, thereby removing small amounts of gas from the evacuated space. As non-limiting examples, the getter can be formed from aluminum, barium, magnesium, calcium, sodium, strontium, caesium, phosphorus, vanadium, cobalt, and/or zirconium. As a non-limiting example, the getter can be formed from an alloy, such as but not limited to a zirconium-vanadium-iron alloy, a zirconium-cobalt-mischmetal alloy, or a zirconium-aluminum alloy.

FIG. 1B illustrates the mechanism for desorption of molecules from a surface based on an accelerated particle, such as but not limited to the surface of a getter. An accelerated particle 150 is directed at the surface 100. As a result of a collision between the accelerated particle 150 and an adsorbed molecule 100 at the surface 100 the molecule is desorbed to provide a desorbed molecule 160.

An example method of pumping according to the principles described herein is as follows. A low-power vacuum can be coupled to a chamber to reduce the pressure of gas molecules in the chamber to a value in the range of about 10⁻² Torr to about 10⁻³ Torr. Energy can be supplied to the chamber, such as described above in connection with FIG. 1B, to cause desorption of molecules from at least a portion of a surface of the chamber. The desorbed molecules can then be evacuated from the chamber using the low-vacuum pump. For example, the desorption of the molecules can cause a rise in pressure in the chamber. The low-power pump can be in communication with at the chamber at a setting to return the pressure to a value in the range of about 10⁻² Torr to about 10⁻⁴ Torr. The chamber then can be isolated from the low-vacuum pump, such that there is substantially no gaseous exchange between the low-power pump and the chamber. The supply of energy to the surface of the chamber is discontinued. At this stage, at least a portion of a surface of the chamber is substantially adsorbate-free, i.e., substantially free of the monolayer of adsorbed molecules at the surface. Gas molecules in the volume of the chamber are adsorbed at the adsorbate-free surface, thereby causing a further reduction of the pressure in the chamber even though the chamber is isolated from any pump. That is, even though the chamber is substantially isolated from any pump, and nor being supplied with energy, a further reduction of the pressure in the chamber is obtained. For example, the pressure can be further reduced to achieve pressures as low as about 10⁻⁷ Torr to about 10⁻⁹ Torr. In an example, the adsorbate-free surface is formed at a surface of a getter disposed in the chamber. In an example, an ultra-high vacuum can be created inside the chamber using a method according to the principles described herein.

An example chamber according to the principles described herein can be made of a metal, a metal alloy, a plastic, a transparent oxide, a polymer, a ceramic, or any combination thereof. For example, the example chamber may be formed from stainless steel, aluminum, mild steel, brass, high density ceramic, glass, acrylic, or any combination thereof.

An example method according to the principles described herein can be applied to a chamber to generate at least one substantially adsorbate-free portion of a surface of a getter disposed in a chamber. The chamber is substantially isolated from a pump. Gas molecules in the volume of the chamber can be captured on the at least one substantially adsorbate-free portion of the surface of the getter. As a result, the number of molecules in the gas phase in the chamber is reduced, and consequently the chamber pressure is reduced. Example systems, apparatus and methods described herein also provide a pumping device that can be used to implement the pumping method, to achieve very high vacuums. An example system, apparatus and method described herein also can be used to achieve pressures as low as about 10⁻⁹ Torr in a chamber from starting pressures in the range of about 10⁻³ Torr.

The principle for producing an adsorbate-free surface is as follows. To desorb a molecule from the surface of a solid, the energy of the molecule should be raised by more than the energy released during adsorption of that molecule on the surface, i.e., the heat of adsorption. An example method to transfer the required energy to the adsorbed molecule is by heating the surface using various methods, such as but not limited to by resistive or radiative heating. The heating method may not be desirable for some applications due to potential for a lack of temperature compatibility between the contents of the chamber and the temperatures necessary to desorb the adsorbed molecules. In another example, heating method may not be compatible due to a risk of surface degradation and low power efficiency due to thermal conduction in the bulk of the material of the chamber. The energy of the adsorbed molecules can be raised using charged particles in a bombardment process. The excitation of the surface adsorbed molecules can be performed by energetic electrons or ions that can be greatly accelerated using an applied electric field. The electrons can be emitted by thermionic sources or field emission devices. Methods to generate ions include gas discharge, DC and RF plasmas, electron impact ionization, and field ionization. The generated ions or emitted electrons can be accelerated towards the surface and excite the surface adsorbed molecules by collision. The charged particle bombardment method can be more efficient than the heating method, since the accelerated particles directly interact with the surface adsorbates and the energy of the particles may not be thermalized (long-tail distribution). As a non-limiting example, many example large area electron emitters and gas ionizers in the art may be implemented for providing the charged particle bombardment in the chamber for the pumping mechanisms described herein. It is beneficial if the large area electron emitters and gas ionizers exhibit excellent performance, including high transmission, low operating voltage, and long-term stability. For example, large area electron emitters and gas ionizers exhibiting such excellent performance can be fabricated according to any example system or method described in provisional application No. 61/733,180, filed Dec. 4, 2012, U.S. provisional application No. 61/843,784, filed Jul. 8, 2013, U.S. provisional application No. 61/843,805, filed Jul. 8, 2013, or U.S. provisional application No. 61/845,522, filed Jul. 12, 2013, and used for providing the charged particle bombardment in the chamber for the pumping mechanisms described herein.

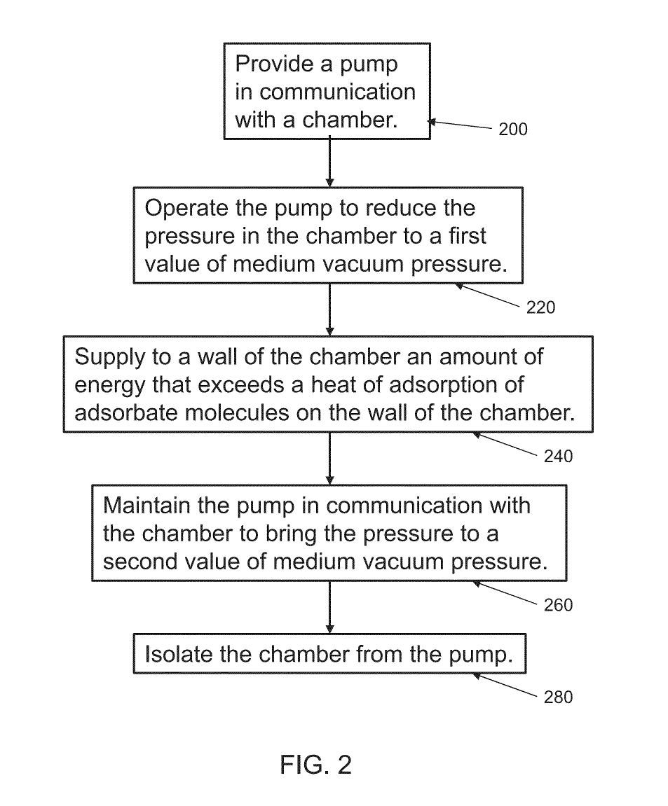

FIG. 2 shows a flow-chart of method for generating a vacuum in a chamber. The example method can be implemented on an example system that includes a pump in communication with a chamber (block 200). In block 220, a pump in communication with a chamber is operated to reduce a pressure in the chamber to a first value of medium vacuum pressure. In block 240, an amount of energy that exceeds a heat of adsorption of adsorbate molecules on the wall of the chamber is supplied to a wall of the chamber. In an example, the amount of energy can be supplied by ion bombardment, by electron bombardment, and/or through heating. In block 260, the pump is maintained in communication with the chamber to bring the pressure in the chamber to a second value of medium vacuum pressure. In block 280, the chamber is isolated from the pump. According to the principles herein, at least a portion of a surface in the chamber is substantially adsorbate-free, i.e., substantially free of the monolayer adsorbate molecules. As described above, the pressure in the isolated chamber decreases from the second value of medium vacuum pressure to a lower value of pressure even in the absence of additional evacuation of the chamber.

The amount of energy that exceeds the heat of adsorption of adsorbate molecules on the wall of the chamber can depend on the type of molecule adsorbed on the surface, and the type of material of the surface. For example, the amount of energy per molecule of the monolayer can be about 0.05 eV, about 0.1 eV, about 0.5 eV, about 1 eV, about 5 eV, about 7.5 eV, about 10 eV, or about 12 eV per molecule.

As non-limiting example, the pump can be operated as described herein to generate a first value of medium vacuum pressure, or a second value of medium vacuum pressure, that falls within the range from about 1×10⁻¹ Torr to about 1×10⁻⁶ Torr. As a non-limiting example, the pump can be operated as described herein to generate a first value of medium vacuum pressure, or a second value of medium vacuum pressure, of about 1×10⁻³ Torr.

As non-limiting examples, the pressure in the isolated chamber can be decreased from the second value of medium vacuum pressure to a lower value of pressure within a range from about 1×10⁻⁷ Torr to about 1×10⁻¹⁰ Torr. For example, the pressure in the isolated chamber can be decreased from the second value of medium vacuum pressure to a lower value of pressure of about 1×10⁻⁹ Torr.

In an example implementation, the amount of energy can be supplied by ion bombardment or electron bombardment (as described in connection with block 240). For example, the ion bombardment can be supplied using one or more of a field emitter, a field ionizer, or a thermionic source. The source of ion bombardment can be disposed in or coupled to a portion of the chamber. For example, the electron bombardment can be supplied using one or more of a gas discharge, a direct-current plasma, a radio-frequency plasma, electron impact ionization, or field ionization. The source of electron bombardment can be disposed in or coupled to a portion of the chamber.

In an example implementation, the amount of energy can be supplied through heating (as described in connection with block 240). For example, the heating can be supplied using a radiative heater and/or a resistive heater disposed in or coupled to the chamber.

In another example implementation, the amount of energy can be supplied by any combination of ion bombardment, electron bombardment, and/or through heating, using any example technology described above.

In non-limiting example implementations, the pump can be a mechanical pump, a positive displacement pump, a diffusion pump, a turbomolecular pump, a Knudsen pump, a cryo-pump or an ion pump. Non-limiting examples of positive displacement pumps that can be used include a rotary pump, a scroll pump, a screw pump, and a diaphragm pump.

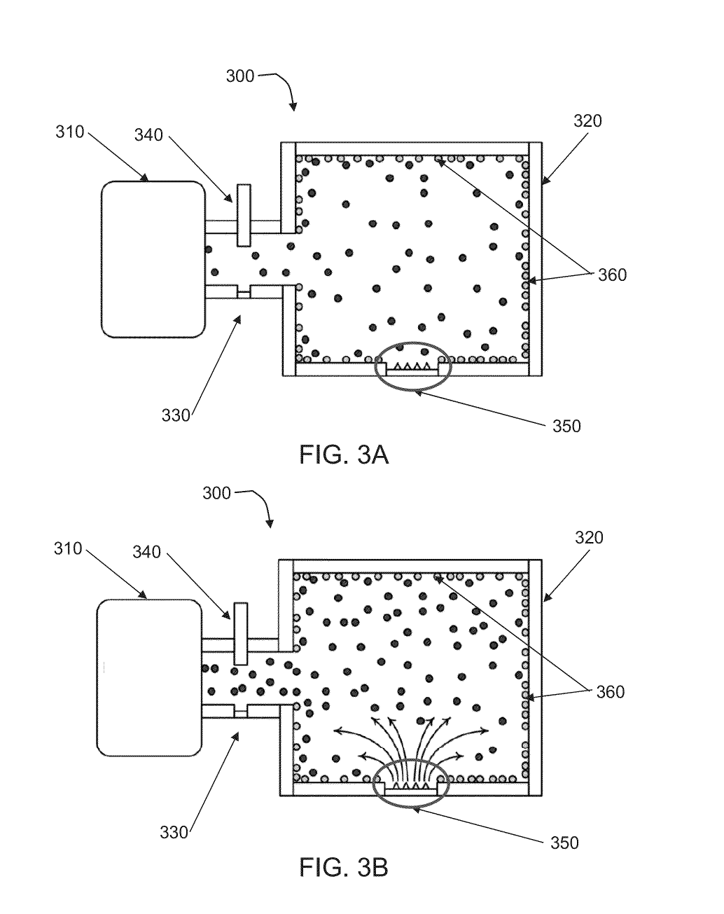

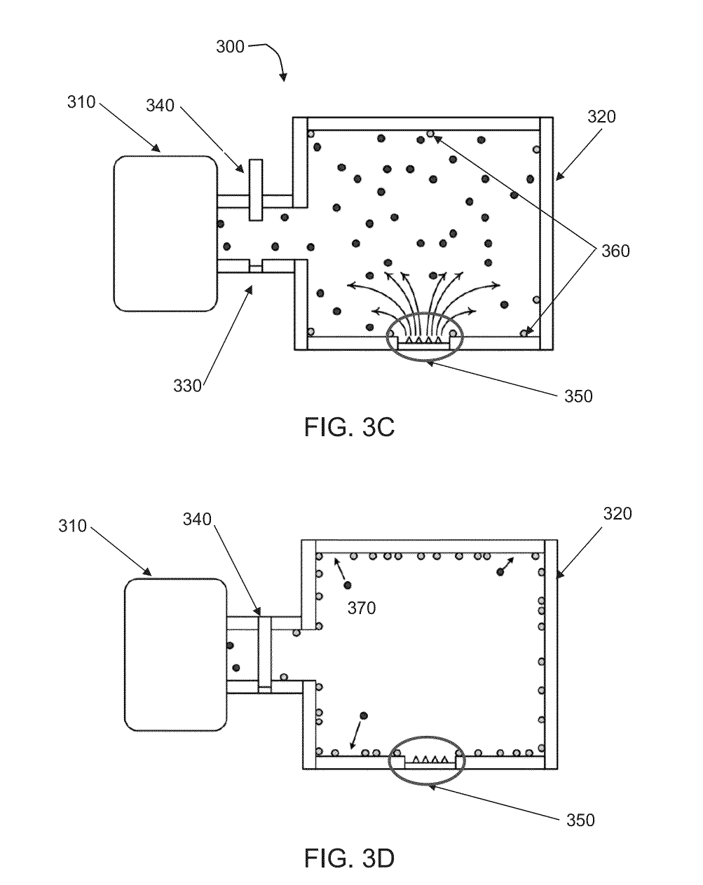

FIGS. 3A-3D show an example pumping sequence that can be applied to an example system according to the principles described herein. The example system 300 includes a vacuum pump 310, a chamber 320 coupled to the vacuum pump 310 via a port 330, and a valve 340 disposed in a region of the port 330. An energy source 350 to promote desorption of adsorbed molecules 360 from a portion of a surface of the chamber can be coupled to or disposed in a portion of the chamber 320. As illustrated in FIG. 3A, valve 340 at a setting that allows exchange of gases between chamber 320 and vacuum pump 310. Chamber 320 is pumped using vacuum pump 310 to a medium vacuum pressure. In this example, the energy source 350 is a source of accelerated charged particles. As shown in FIG. 3B, energy source 350 is operated to generate energetic electrons or ions which can be accelerated towards a portion of the surface of the chamber 320 in a process of ion or electron bombardment. The energy exchange with the adsorbed molecules 360 based on the collisions with the accelerated ions or electrons cause the surface-adsorbed molecules 360 to be desorbed from a portion of the surface of the chamber 320. As shown in FIG. 3C, the density of adsorbed molecules 360 adsorbed on the inner surface of the chamber is reduced over time. Valve 340 at maintained at the setting that allows exchange of gases between chamber 320 and vacuum pump 310. The chamber 320 is retuned to a medium vacuum pressure. According to the principles herein, at least a portion of a surface in the chamber is substantially adsorbate-free, i.e., substantially free of the monolayer adsorbed molecules 360. As shown in FIG. 3D, the valve 340 is closed to isolate chamber 320 from gaseous exchange with vacuum pump 310. The supply of charged particles to the surface is discontinued. As described above, the pressure in the isolated chamber decreases from the medium vacuum pressure to a lower value of pressure even in the absence of additional evacuation of the chamber. As shown in FIG. 3D, the chamber pressure decreases due to adsorption of molecules 370 at the substantially adsorbate-free surface.

In the example of FIGS. 3A-3D, a portion of the inner surface of the chamber can be coated with a reactive material such that it can be used as a getter.

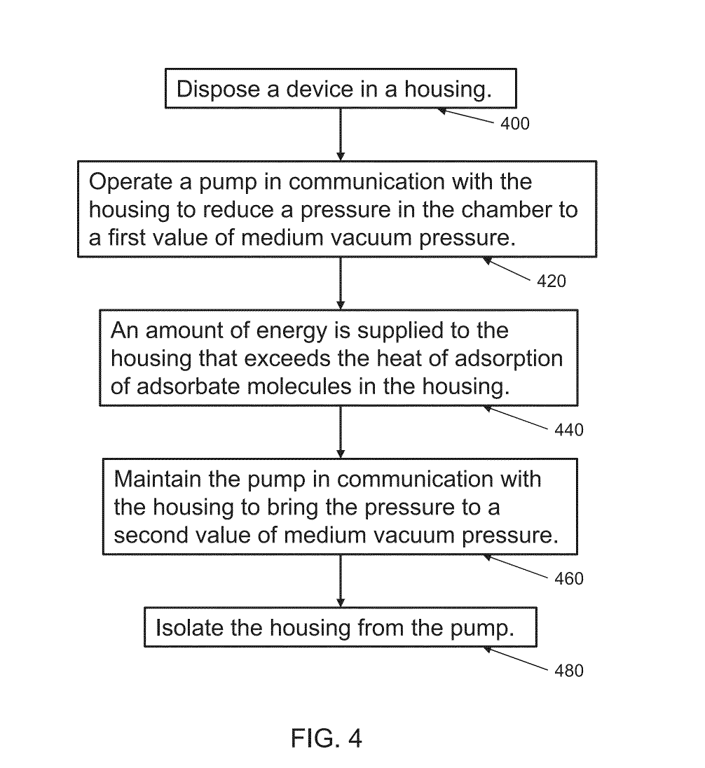

FIG. 4 shows a flowchart of an example method for packaging a device under a vacuum, using a pumping sequence according to the principles described herein. In block 400, the device is disposed in a housing. In block 420, a pump in communication with the housing is operated to reduce the pressure in the housing to a first value of medium vacuum pressure. An amount of energy is supplied to the housing that exceeds the heat of adsorption of adsorbate molecules in the housing (see block 440). The housing is maintained in communication with the pump to bring the pressure in the housing is at a second value of medium vacuum pressure (see block 460). In block 480, the housing is isolated from the pump. As described above, at least a portion of the housing is an adsorbate-free surface. Thus, gas molecules within the housing adsorb on the adsorbate-free surface, resulting in a reduction in the pressure in the housing. The pressure in the housing decreases from the second value of medium vacuum pressure to a lower value of pressure in the absence of additional evacuation of the housing.

The amount of energy can be supplied by ion bombardment, electron bombardment, or heating. In an example where the amount of energy is supplied by ion bombardment, the ion bombardment can be supplied using at least one field emitter, at least one field ionizer, or at least one thermionic source. In an example where the amount of energy is supplied by electron bombardment, the electron bombardment is supplied using at least one of a gas discharge, a direct-current plasma, a radio-frequency plasma, electron impact ionization, and field ionization.

As a non-limiting example, the device can be a micro-electromechanical system (MEMS) device, a sensor, a mass spectrometer, a gas chromatography system, or a tandem system.

As other non-limiting examples, the device can include a magnetometer, an atomic clock, a gyroscope, an interferometer, an accelerometer, a gravimeter, an electric field sensor, a magnetic sensor, a pressure sensor, a gravity gradiometer, a power amplifier, or a terahertz generator.

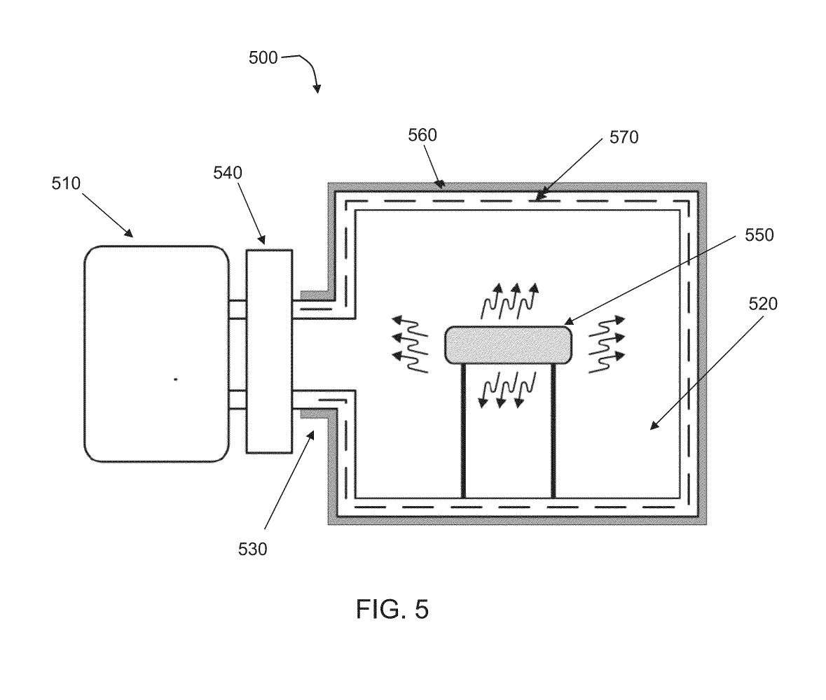

FIG. 5 shows a schematic of an example system 500 according to the principles described herein that includes a heating or illuminating energy sources coupled to the chamber. The example system 500 includes a vacuum pump 510, a chamber 520 coupled to the vacuum pump 510 via a port 530, and a valve 540 disposed in a region of the port 530. At least one energy source to promote desorption of adsorbed molecules from a portion of a surface of the chamber 520 can be coupled to or disposed in a portion of the chamber 520. For example, the energy source can be a resistive, inductive, or radiative heating component 550 that is disposed in a portion of the chamber 520. As another example, the energy source can be a resistive, inductive, or radiative heater 560 wrapped around at least a portion of chamber 520. As yet another example, the energy source can be a heater component 570 embedded in a portion of a wall of the chamber 520.

An example metric for estimating the pumping capacity of an example system according to the principles described can be computed as follows. The pumping capacities as high as about 100 cm³ volume at about 10⁻⁵ Torr pressure are estimated for a pump with about 1 cm² pumping surface. This calculation is based on assuming permanent adsorption of about 5% of the theoretical density of molecules adsorbed in one monolayer. This can be achieved with exposing the surface of the getter with currents in the range of about 1 A/cm² using the energy source devices.

The flux of electrons colliding with the surface of the getter at a current density of about 1 A/cm² is:

Fₑ=Jₑ/q=6.25×10¹⁸ cm⁻²s⁻¹.

On the other hand, the flux of gas molecules (Fₘ) imping on the surface of the getter can be expressed as a linear function of pressure, P, and calculated by:

Fₘ=P(2πmkT)^{-1/2},

where A is the surface of the getter, m average mass of the gas molecules, k Boltzmann constant, and T the gas temperature. From this equation, for a chamber filled with nitrogen and held at a pressure of the 10⁻⁴ Torr, the flux of molecules (Fₘ) hitting the surface of the getter can be computed as:

Fₘ=3.83×10¹⁶ cm⁻²s⁻¹.

A comparison of these flux values indicates that for each molecule there are more than about 150 electrons colliding with the getter. Moreover, the energy of the electrons can be practically adjusted to about 100 eV-about 1000 eV or more that is significantly larger than the heat of adsorption (about 5 eV-about 10 eV) for the adsorbed molecules. Therefore, most types of molecules can be desorbed from the surface is expected using bombardment due to high energy and flux of impinging electrons. Indeed, the pumping capacities of the devices according to the principles described herein could be significantly larger than as estimated.

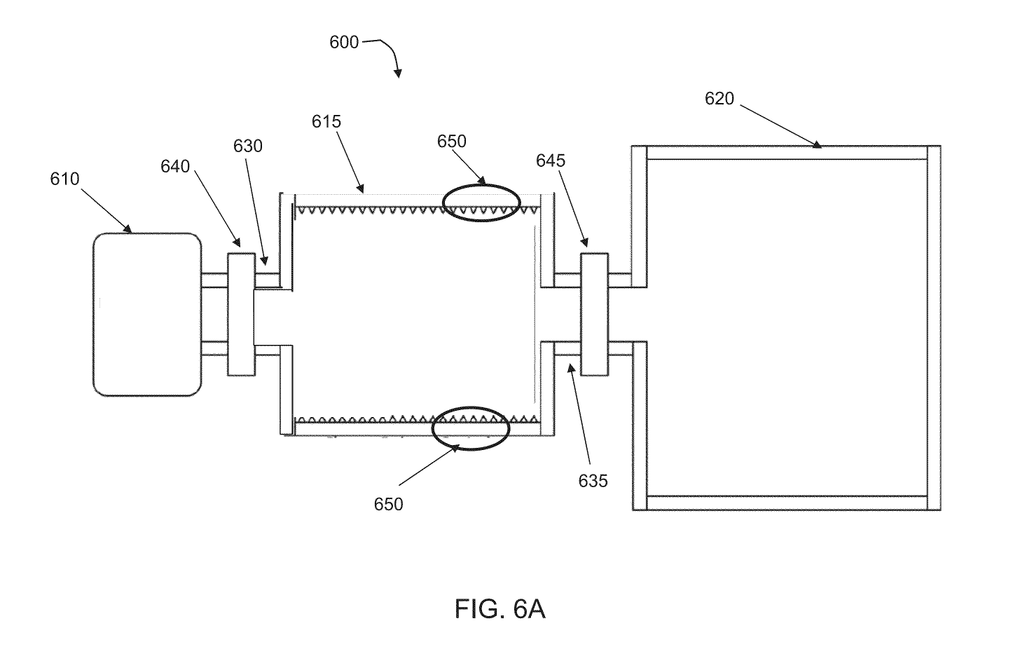

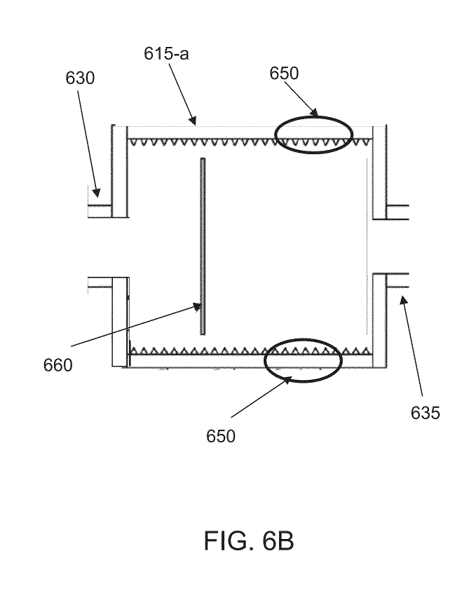

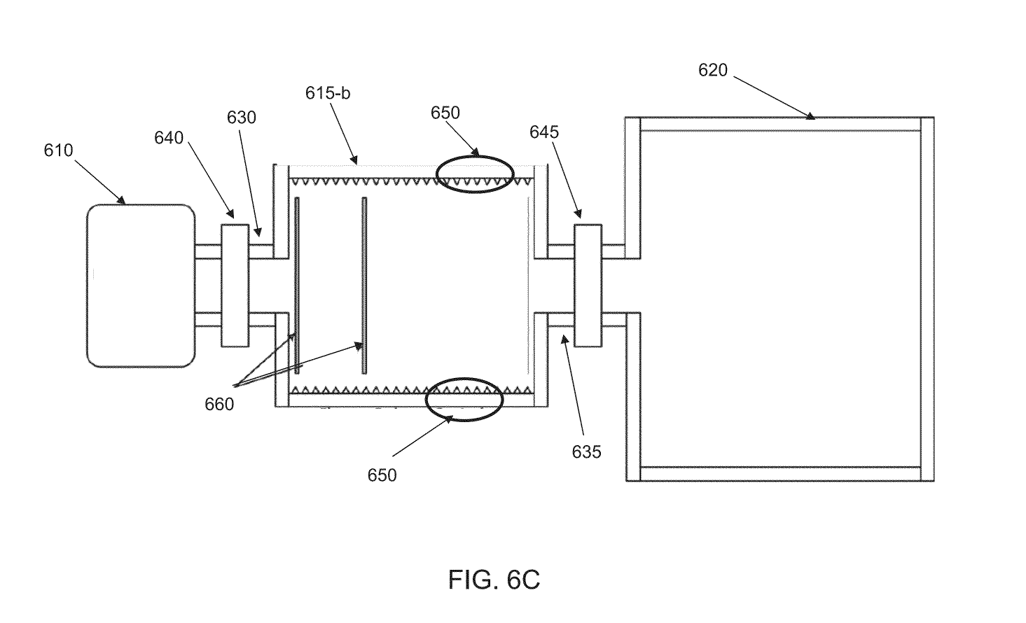

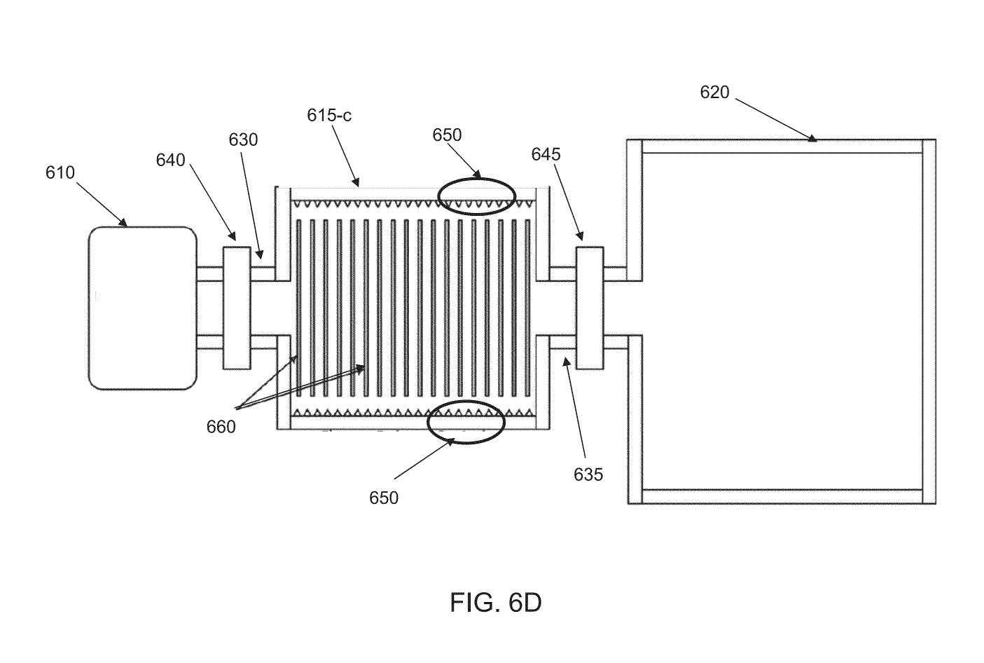

FIG. 6A shows a non-limiting example of a two-stage system 600 that can be operated as a high vacuum pump according to the principles described herein. The two-stage system 600 can be operated as an ultra-high vacuum (UHV) pump that exploits the surface adsorption phenomenon described herein to generate an ultra-high vacuum in the absence of additional evacuation. The example two-stage system 600 includes a vacuum pump 610, a pump chamber 615, and a main chamber 620. The pump chamber 615 is coupled to the vacuum pump 610 via a first port 630, and is coupled to the main chamber 620 via a second port 635. Second port 635 facilitates gaseous communication between the main chamber 620 and pump chamber 615. A first valve 640 is coupled to the first port 630. A second valve 645 is coupled to the second port 635. Valve 640 or valve 645 can be set to substantially eliminates gaseous exchange with pumping chamber 615 through the respective first port 630 or respective second port 635. At least one energy source 650 to promote desorption of adsorbed molecules from a portion of a surface of the pump chamber 615 can be coupled to or disposed in a portion of the pump chamber 615. In an example, the energy source 650 can be a heating source, a source for ion bombardment, or a source for electron bombardment, disposed in or coupled to a portion of the pump chamber 615.

In an example, the least one energy source 650 can be a source for electron bombardment, such as but not limited to a field emitter, a field ionizer, or a thermionic source.

In an example, the least one energy source 650 can be a source for ion bombardment, such as but not limited to a gas discharge, a direct-current plasma, a radio-frequency plasma, an electron impact ionization source, or a field ionization source.

In an example, the least one energy source 650 can be an array of field emitters and/or gas ionizers. The array of field emitters/gas ionizers can be used to generate energetic electrons or ions, which can be accelerated towards a portion of the surface of the pump chamber 615.

In an example, the least one energy source 650 can be include a heating source, such as but not limited to a resistive, inductive, or radiative heating component, that is disposed in a portion of the chamber 620, wrapped around at least a portion of chamber 620, and/or embedded in a portion of a wall of the chamber 620.

FIG. 6B shows a non-limiting example of a pump chamber 615-a that includes a first port 630, a second port 635, energy source 650, and one or more adsorbent plates 660. The first port 630 of pump chamber 615-a is configured to couple to a vacuum pump. As shown in FIG. 6B, pump chamber 615-a can include at least one energy source 650. Energy source 650 can be at least one source for ion bombardment or electron bombardment disposed in or coupled to a portion of the pump chamber 615-a. The energy supplied to the chamber by energy source 650 can be applied according to the method described herein to generate an adsorbate-free surface on at least a portion of the adsorbent plate 660. At a stage that the pump chamber 615 is isolated from gaseous exchange with any other component, the adsorbate-free portions of the surface of adsorbent plates 660 can provide additional gas molecule adsorption capacity, thereby generating a lower pressure in pump chamber 615-a. For example, a high vacuum (such as a vacuum pressure in a range of about 10⁻⁶ Torr to about 10⁻⁹ Torr), or an ultra-high vacuum (such as a vacuum pressure of less than about 10⁻⁹ Torr), can be generated in isolated pump chamber 615-a.

In any example system described herein, at least a portion of the adsorbent plate 660 can be coated with an adsorption-promoting material to serve as a getter. As a non-limiting example, at least a portion of the adsorbent plate 660 can be coated with getter materials used in non-evaporable getter pumps. In any example system described herein, at least a portion of the adsorbent plate 660 can be configured to have a surface texture that provides a high surface-to-volume ratio. In any example system described herein, at least a portion of the adsorbent plate 660 can be coated with a high surface-to-volume ratio material, such as but not limited to an aerogel, a porous template structure, a graphene structure, or a nanofiber.

In the non-limiting example of FIG. 6C, example two-stage system 600 includes a vacuum pump 610, a pump chamber 615-b, and a main chamber 620. The pump chamber 615-b is coupled to the vacuum pump 610 via a first port 630, and is coupled to the main chamber 620 via a second port 635. Second port 635 facilitates gaseous communication between the main chamber 620 and pump chamber 615-b. A first valve 640 is coupled to the first port 630. A second valve 645 is coupled to the second port 635. Pump chamber 615-b is shown to include adsorbent plates 660. Setting valve 640 or valve 645 substantially eliminates gaseous exchange through the respective first port 630 or respective second port 635. At least one energy source 650 coupled to or disposed in a portion of the pump chamber 615 is used to promote desorption of adsorbed molecules from a portion of a surface of the pump chamber 615 (including the surface of any adsorbent plates 660 disposed in pump chamber 615). In an example, the energy source 650 can be a source for ion bombardment, or a source for electron bombardment, disposed in or coupled to a portion of the pump chamber 615. FIG. 6D shows yet another non-limiting example that includes the components of FIG. 6C, but where pump chamber 615-c includes a number of adsorbent plates 660, arranged in an array. At least one of the adsorbent plates 660 of pump chamber 615-b or 615-c can be coated to serve as a getter. The energy supplied to the chamber by energy source 650 can be applied according to the method described herein to generate an adsorbate-free surface on at least a portion of at least one adsorbent plate 660. At a stage that the pump chamber 615-b or 615-c is isolated from the vacuum pump 610, the adsorbate-free portions of the surface of adsorbent plates 660 can provide additional gas molecule adsorption capacity, thereby generating a lower pressure in pump chamber 610. For example, the two-stage system 600 can be operated to generate a high vacuum (such as a vacuum pressure in a range of about 10⁻⁶ Torr to about 10⁻⁹ Torr), or an ultra-high vacuum (such as a vacuum pressure of less than about 10⁻⁹ Torr), in pump chamber 615-b. Furthermore, based on the use of the methods described herein to generate adsorbate-free surfaces adsorbent plates 660, greater amounts of gas molecule can be adsorbed, thereby increasing the adsorption capacity in pump chamber 615-b. Pump chamber can be used to generate a high vacuum or an ultra-high vacuum in main chamber 620, according to the methods described herein.

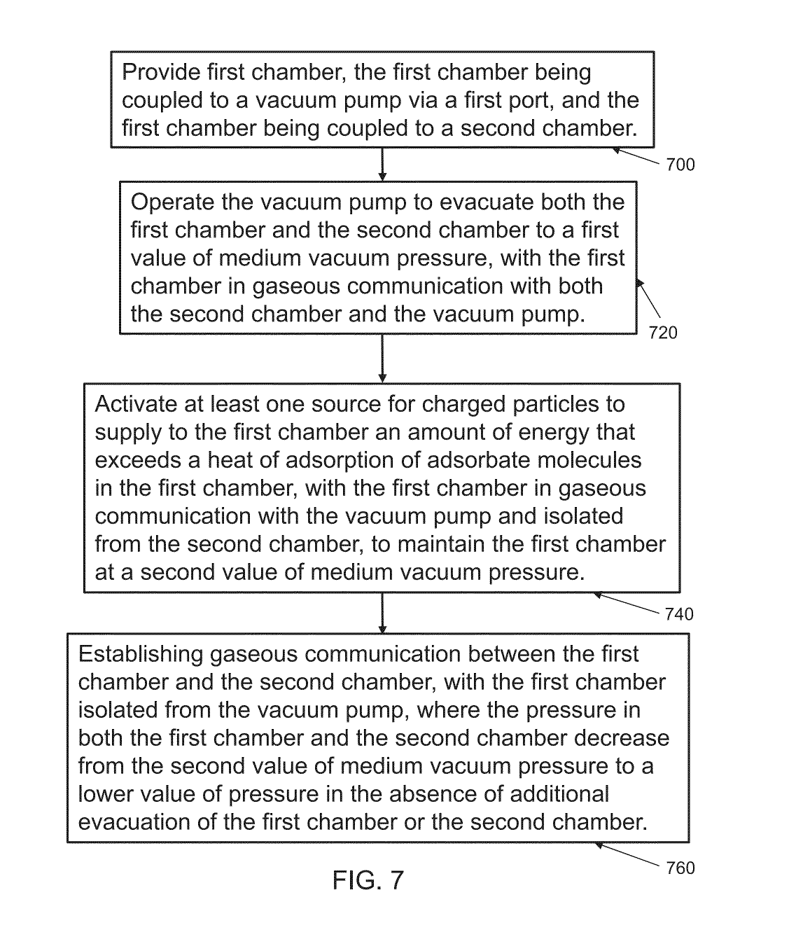

A low-chart of an example method for generating a vacuum using a two-stage surface adsorption pump according to the principles described herein is as follows (with reference to FIG. 7). As shown in block 700, the method can be performed using a system that includes a first chamber coupled to a second chamber and also coupled to a vacuum pump via a first port. In block 720, a vacuum pump is operated the vacuum pump to evacuate both the first chamber and the second chamber to a first value of medium vacuum pressure, with the first chamber in gaseous communication with both the second chamber and the vacuum pump. In block 740, at least one source for charged particles is activated to supply to the first chamber an amount of energy that exceeds a heat of adsorption of adsorbate molecules in the first chamber, with the first chamber in gaseous communication with the vacuum pump and isolated from the second chamber, to maintain the first chamber at a second value of medium vacuum pressure. In block 760, the method includes establishing gaseous communication between the first chamber and the second chamber, with the first chamber isolated from the vacuum pump. The pressure in both the first chamber and the second chamber decrease from the second value of medium vacuum pressure to a lower value of pressure in the absence of additional evacuation of the first chamber or the second chamber.

The example method described in the flow-chart of FIG. 7 can be performed using any of the example two-stage systems of FIG. 6A, 6C, or 6D.

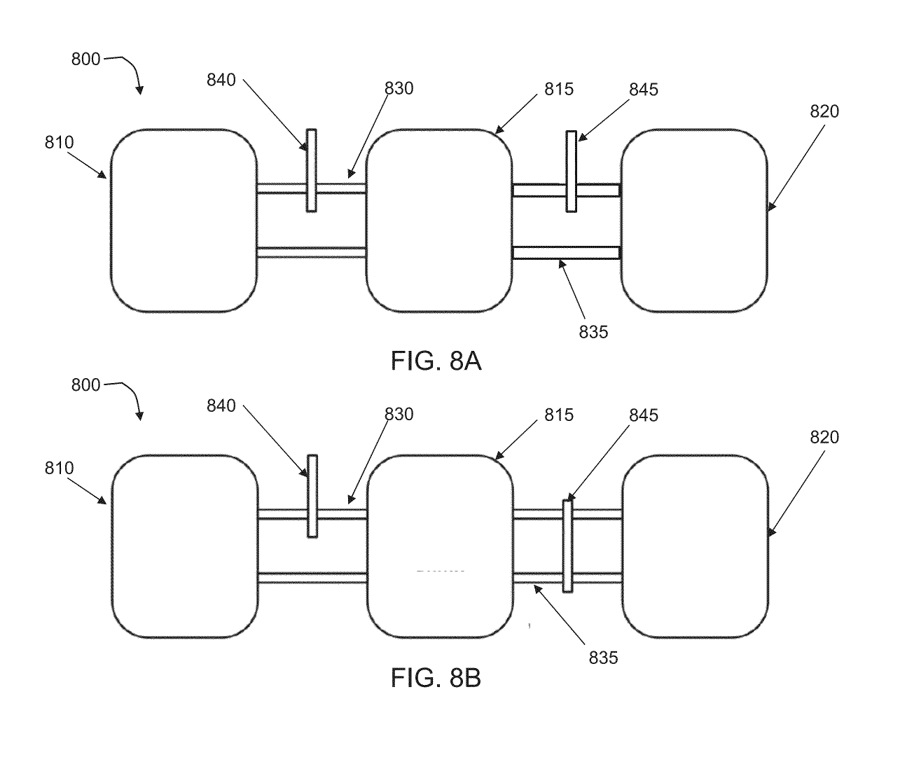

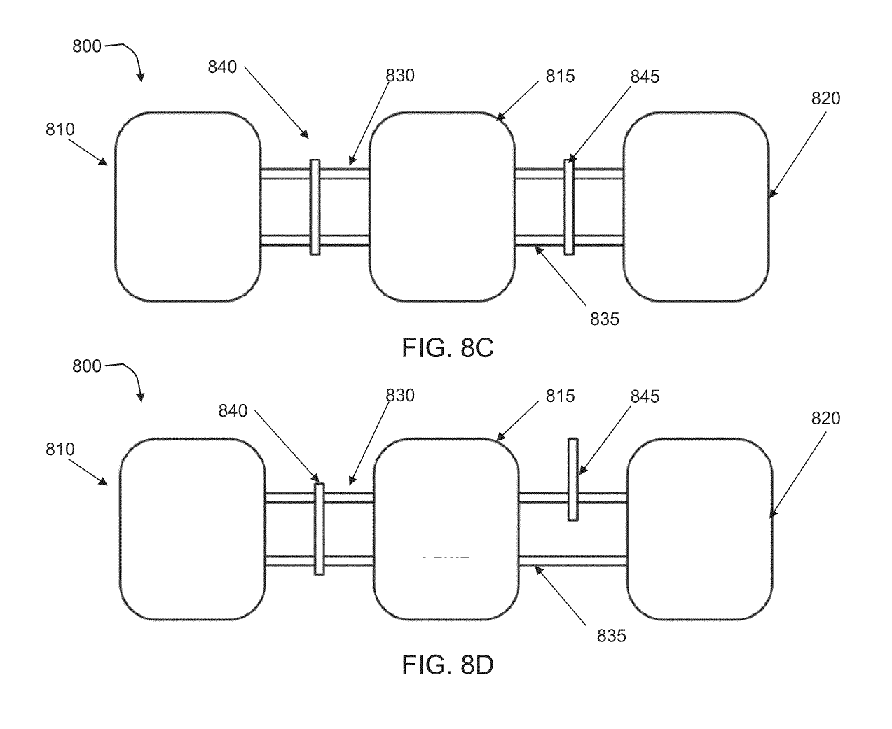

FIGS. 8A-8D show a non-limiting example operation sequence of an example two-stage system 800, where the device is used as a second stage of a compound pump for vacuum pumping a chamber. Example system 800 can be operated as an ultra-high vacuum (UHV) pump that exploits the surface adsorption phenomenon described herein to generate an ultra-high vacuum in the absence of additional evacuation. The example two-stage system 800 includes a vacuum pump 810, a pump chamber 815, and a main chamber 820. The pump chamber 815 is coupled to the vacuum pump 810 via a first port 830, and is coupled to the main chamber 820 via a second port 835. Second port 835 facilitates gaseous communication between the main chamber 820 and pump chamber 815. A first valve 840 is coupled to the first port 830. A second valve 845 is coupled to the second port 835. Valve 840 or valve 845 can be set to substantially eliminates gaseous exchange with pumping chamber 815 through the respective first port 830 or respective second port 835. At least one energy source can be coupled to or disposed in a portion of the pump chamber 815 to promote desorption of adsorbed molecules from a portion of a surface of the pump chamber 815 (including the surface of any adsorbent plates disposed in pump chamber 815). In any example herein, the energy source 850 can be a heating source, a source for ion bombardment, or a source for electron bombardment, disposed in or coupled to a portion of the pump chamber 815, including but not limited to the types of energy sources described in connection with FIGS. 3A-3D, 5, and 6A-6D.

As shown in FIG. 8A, valves 840 and 845 are set such that the pump chamber 815 is initially in gaseous communication with both the vacuum pump 810 and the main chamber 820 (both valves 840 and 845 are open). The vacuum pump 810 is operated to reduce the pressure in both the vacuum pump 810 and the main chamber 820 to a first value of medium vacuum pressure. The first value of medium vacuum pressure can take on a value within a range from about 1×10⁻¹ Torr to about 1×10⁻⁶ Torr.

As shown in FIG. 8B, the pump chamber 815 maintained in gaseous communication with the vacuum pump 810 (valve 840 is open) and isolated from the main chamber 820 (valve 845 is open). At least one energy source in the pump chamber 815, such as but not limited to a heating source or a source for charged particles, is activated to supply to the pump chamber 815 an amount of energy that exceeds a heat of adsorption of adsorbate molecules in the pump chamber 815. In various examples, the energy source may deliver an amount of energy of about 0.05 eV, about 0.1 eV, about 0.5 eV, about 1 eV, about 5 eV, about 7.5 eV, about 10 eV, or about 12 eV, or more. The pump chamber 815 is maintained in communication with the vacuum pump 810 until the pressure is maintained at a second value of medium vacuum pressure. At this stage, adsorbate-free surfaces are generated on portions of the surface of pump chamber 815 (including on the surface of any adsorbent plates disposed in pump chamber 815). The second value of medium vacuum pressure can take on a value within a range from about 1×10⁻¹ Torr to about 1×10⁻⁶ Torr.

As shown in FIG. 8C, the pump chamber 815 is isolated from gaseous exchange with both vacuum pump 810 and main chamber 820 (both valves 840 and 845 are closed). At this stage, gas molecules in the pump chamber 815 are adsorbed on any substantially adsorbate-free surfaces generated in the pump chamber 815. As a result, the pressure in the pump chamber 815 decreases from the second value of medium vacuum pressure to a lower value of pressure in the absence of additional evacuation of the pump chamber using vacuum pump 810. The lower value of pressure can take on a value within a range from about 1×10⁻⁷ Torr to about 1×10⁻¹⁰ Torr. For example, a high vacuum or an ultra-high vacuum can be generated in pump chamber 815.

As shown in FIG. 8D, the pump chamber 815 is set in gaseous communication with the main chamber 820 (valve 845 is open) and is maintained isolated from vacuum pump 810 (valve 840 is closed). The pumping chamber is used to reduce the pressure of the main chamber 820 through adsorption of gas molecules at the substantially adsorbate-free surfaces generated in the pump chamber 815. For example, a high vacuum or an ultra-high vacuum can be generated in main chamber 820 using the enhanced pumping capacity of pump chamber 815.

The example sequence illustrated in FIGS. 8A-8D can be performed to achieve the desired pressure in the main chamber 820. Furthermore, one or more adsorbent plates can be mounted inside the pump chamber 815 to increase the surface area for generation of additional substantially adsorbate-free surfaces, and consequently the pumping capacity of the system, as described hereinabove.

In another non-limiting example sequence, the processes illustrated in FIGS. 8B and 8C can be performed in sequence repeatedly, such as two times, three times, or more, to achieve the desired pressure in the pump chamber 815, prior to proceeding to the process illustrated in FIG. 8D to achieve the desired pressure in the main chamber 820.

The systems, methods and apparatus described herein can be implemented for use on systems at the length scales and dimensions of integrated chips. For example, a system, method and apparatus described herein can be used for chip-scale vacuum pumping to pressures below about 10⁻⁵ Torr.

In a non-limiting example, on-chip MEMS vacuum pumps, such as mechanical pumps (including positive displacement and turbomachinery pumps) or Knudsen pumps, can be used as a backing pump for the systems and apparatus described herein.

Any example system or apparatus described herein can be used to derive a compact, low-power UHV pump.

A traditional ion pumps can require physical exchange of the getter or replenishment of clean surfaces by sputtering. Sputter materials from the sputtering process can redeposit on unwanted regions, particularly on any device in the chamber (such as but not limited to the sensors) that require high vacuum to operate, causing degradation of device reliability. A pump system based on an example system or apparatus herein does not require physical exchange of the getter or replenishment of clean surfaces by sputtering after saturation. There is no need for physical exchange of the getter or other surface in the chambers after saturation, as they can be regenerated in-situ without disassembly using any of the methods described herein. The getter or other surface in the chambers can be regenerated many times using nondestructive treatments, such as but not limited to electron emission, low-energy ion bombardment, and/or heating.

Since magnetic fields (B) can be avoided in the implementation of any of the example systems, methods or apparatus described herein. As a result, any example system, method or apparatus herein can be used for such applications as a gyroscope or a magnetic sensor, where precise control of the magnetic field is required for satisfactory operation of such a gyroscope or sensor.

In any example system according to the principles described herein, the pumping chamber can be used as the device chamber. For example, an example system can be operated according to any of the example methods described herein to generate substantially adsorbate-free surfaces. Thus, any chamber described herein can be used as a device chamber, including the pump chamber. That is, it is not necessary to have a separate chamber for the pump and the device, as the device is not subjected to the sputtered particle or extreme heats that it can be exposed to for traditional ion sources.

Any example system, apparatus or method according to the principles described herein can be implemented in many different commercial applications. Non-limiting example applications include portable analytical instruments such as but not limited to mass spectrometers, gas chromatography systems, and hyphenated systems (i.e., tandem systems that result in far great analytical information power.

In other implementations, the example system, apparatus or method according to the principles described herein can be implemented to generate UHV MEMS packaging for such devices as high power amplifiers and THz generators, pressure sensors, physical and inertial sensors based on atomic spectroscopy. Non-limiting examples of such physical and inertial sensors based on atomic spectroscopy include atomic clocks, atomic magnetometers, atomic gyroscopes, atomic accelerometers, atomic gravimeters, atomic gravity gradiometers, and atomic electric field sensors.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy disks, compact disks, optical disks, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for generating a vacuum in a chamber, comprising:
operating a pump in communication with a chamber to reduce a pressure in the chamber to a first value of medium vacuum pressure;
supplying to a portion of the chamber an amount of energy that exceeds a heat of adsorption of adsorbate molecules on a surface of the chamber, wherein the amount of energy is supplied by ion bombardment, electron bombardment, or heating;
maintaining the chamber in communication with the pump; and
isolating the chamber from the pump while the pressure in the chamber is at a second value of medium vacuum pressure,
wherein the pressure in the chamber decreases from the second value of medium vacuum pressure to a lower value of pressure in the absence of additional evacuation of the chamber.

2. The method of claim 1, further comprising supplying the amount of energy by ion bombardment or electron bombardment.

3. The method of claim 2, wherein the ion bombardment is supplied using at least one field emitter, at least one field ionizer, or at least one thermionic source, and wherein the at least one field emitter, at least one field ionizer, or at least one thermionic source is disposed in or coupled to a portion of the chamber.

4. The method of claim 2, wherein the electron bombardment is supplied using at least one of a gas discharge, a direct-current plasma, a radio-frequency plasma, electron impact ionization, and field ionization, disposed in or coupled to a portion of the chamber.

5. The method of claim 1, further comprising supplying the amount of energy by heating, wherein said heating is supplied using at least one radiative heater or at least one resistive heater disposed in or coupled to a portion of the chamber.

6. The method of claim 1, further comprising discontinuing the supplying of the amount of energy to the portion of the chamber prior to isolating the chamber from the pump.

7. The method of claim 1, wherein the pump is a mechanical pump, a turbo-pump, a positive displacement pump, a diffusion pump, a turbomolecular pump, a Knudsen pump, a cryo-pump or an ion pump.

8. The method of claim 7, wherein the positive displacement pump is a rotary pump, a scroll pump, a screw pump, and a diaphragm pump.

9. The method of claim 1, wherein the first value of medium vacuum pressure and/or the second value of medium vacuum pressure has a value within a range from about 1×10⁻¹ Torr to about 1×10⁻⁹ Torr.

10. The method of claim 1, wherein the first value of medium vacuum pressure and/or the second value of medium vacuum pressure is about 1×10⁻³ Torr.

11. The method of claim 1, wherein the lower value of pressure has a value within a range from about 1×10⁻⁵ Torr to about 1×10⁻¹⁰ Torr.

12. The method of claim 1, wherein the lower value of pressure is about 1×10⁻⁹ Torr.

13. The method of claim 1, wherein the amount of energy is about 0.05 eV, about 0.1 eV, about 0.5 eV, about 1 eV, about 5 eV, about 7.5 eV, about 10 eV, or about 12 eV.

14. The method of claim 1, further comprising maintaining the chamber in communication with the pump until an equilibrium pressure is reached at a base pressure of the pump.

15. The method of claim 1, further comprising discontinuing the supplying the amount of energy after isolating the chamber from the pump.

16. A method for packaging at least one device under a vacuum, comprising:
disposing the at least one device in a housing;
operating a pump in communication with the housing to reduce a pressure in the housing to a first value of medium vacuum pressure;
supplying to the housing an amount of energy that exceeds a heat of adsorption of adsorbate molecules in the housing, while maintaining the housing in communication with the pump, wherein the amount of energy is supplied by ion bombardment, electron bombardment, or heating; and
isolating the housing from the pump when the pressure in the housing is at a second value of medium vacuum pressure,
wherein the pressure in the housing decreases from the second value of medium vacuum pressure to a lower value of pressure in the absence of additional evacuation of the housing.

17. The method of claim 16, further comprising supplying the amount of energy by ion bombardment, wherein the ion bombardment is supplied using at least one field emitter, at least one field ionizer, or at least one thermionic source.

18. The method of claim 16, further comprising supplying the amount of energy by electron bombardment, wherein the electron bombardment is supplied using at least one of a gas discharge, a direct-current plasma, a radio-frequency plasma, electron impact ionization, and field ionization.

19. The method of claim 16, wherein the at least one device is a micro-electromechanical system (MEMS) device, a sensor, a mass spectrometer, a gas chromatography system, or a tandem system.

20. The method of claim 16, wherein the at least one device is a magnetometer, an atomic clock, a gyroscope, an interferometer, an accelerometer, a gravimeter, an electric field sensor, a magnetic sensor, a pressure sensor, a gravity gradiometer, a power amplifier, a terahertz generator.

21. The method of claim 16, wherein the first value of medium vacuum pressure and/or the second value of medium vacuum pressure has a value within a range from about 1×10⁻¹ Torr to about 1×10⁻⁹ Torr.

22. The method of claim 16, wherein the lower value of pressure has a value within a range from about 1×10⁻⁵ Torr to about 1×10⁻¹⁰ Torr.

23. The method of claim 16, wherein the lower value of pressure is about 1×10⁻⁹ Torr.

24. The method of claim 16, wherein the amount of energy is about 0.05 eV, about 0.1 eV, about 0.5 eV, about 1 eV, about 5 eV, about 7.5 eV, about 10 eV, or about 12 eV.

25. A surface adsorption pump, comprising:
a first chamber comprising a first port and a second port, wherein the first port couples to a vacuum pump;
at least one source for ion bombardment or electron bombardment disposed in or coupled to a portion of the first chamber; and
a second chamber in gaseous communication with the first chamber via the second port.

26. The surface adsorption pump of claim 25, wherein the at least one source for electron bombardment is at least one field emitter, at least one field ionizer, or at least one thermionic source.

27. The surface adsorption pump of claim 25, wherein the at least one source for ion bombardment is at least one at least one of gas discharge, direct-current plasma, radio-frequency plasma, electron impact ionization, or field ionization source.

28. The surface adsorption pump of claim 25, further comprising a valve disposed in the first port and/or the second port, wherein closing the valve in the first port and/or the second port substantially eliminates gaseous exchange through the respective first port and/or respective second port.

29. A method for generating a vacuum using a surface adsorption pump, comprising:
providing the surface adsorption pump of claim 25;
using a vacuum pump coupled to the first port to evacuate both the first chamber and the second chamber to a first value of medium vacuum pressure, while the first chamber is in gaseous communication with both the second chamber and the vacuum pump;
activating the at least one source for ion bombardment or electron bombardment to supply to the first chamber an amount of energy that exceeds a heat of adsorption of adsorbate molecules in the first chamber, while the first chamber is in gaseous communication with the vacuum pump and isolated from the second chamber, until the first chamber is at a second value of medium vacuum pressure; and
establishing gaseous communication between the first chamber and the second chamber, while the first chamber is isolated from the vacuum pump;
wherein the pressure in both the first chamber and the second chamber decrease from the second value of medium vacuum pressure to lower values of pressure in the absence of additional evacuation of the first chamber or the second chamber.

30. The method of claim 29, further comprising maintaining the first chamber in communication with the vacuum pump until an equilibrium pressure is reached at a base pressure of the vacuum pump.

31. The method of claim 29, further comprising discontinuing the supply to the first chamber of the amount of energy after isolating the first chamber from the vacuum pump.

32. A surface adsorption pump, comprising:
a first chamber comprising:
a first port that couples to a vacuum pump;
a second port;
at least one adsorption plate disposed in the first chamber; and
at least one source for ion bombardment or electron bombardment disposed in or coupled to a portion of the first chamber.

33. The surface adsorption pump of claim 32, further comprising a second chamber in gaseous communication with the first chamber via the second port.

34. The surface adsorption pump of claim 32, wherein the at least one source for electron bombardment is at least one field emitter, at least one field ionizer, or at least one thermionic source.

35. The surface adsorption pump of claim 32, wherein the at least one source for ion bombardment is at least one at least one of gas discharge, direct-current plasma, radio-frequency plasma, electron impact ionization, or field ionization source.

36. The surface adsorption pump of claim 32, further comprising a valve disposed in the first port and/or the second port, wherein closing the valve in the first port and/or the second port substantially eliminates gaseous exchange through the respective first port and/or respective second port.
